(19) United States
(12) Patent Application Publication
(10) Pub. No.: US 2009/0187903 A1
(43) Pub. Date: Jul. 23, 2009

(54) VIRTUAL MULTIPROCESSOR SYSTEM

(75) Inventors: Akira UEDA, Osaka (JP); Takao YAMAMOTO, Osaka (JP); Shinji OZAKI, Osaka (JP); Masahide KAKEDA, Hyogo (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/346,987

(22) Filed: Dec. 31, 2008

(30) Foreign Application Priority Data
Jan. 23, 2008 (JP) 2008-012810

(51) Int. Cl. G06F 9/455

(52) U.S. Cl. 718/1

(57) ABSTRACT

A virtual multiprocessor system which does not require a memory apparatus for debugging includes: a physical processor, storage units for storing status information indicating respective statuses of logic processors, a dispatch unit which assigns one of the logic processors by switching the logic processors with respect to a physical processor, and an interrupt unit which suspends the processing currently executed by a current logic processor among the logic processors by issuing a debug interrupt request to the current logic processor; in the virtual multiprocessor system, the dispatch unit stores status information corresponding to the current logic processor into one of the storage units in response to the debug interrupt request issued to the current logic processor that is assigned to the physical processor.

### BACKGROUND OF THE INVENTION

(1) Field of the Invention

The present invention relates to a debug mechanism used for software development or hardware operation analysis in a virtual multiprocessor system.

(2) Description of the Related Art

A method widely implemented in conventional debugging techniques for processors is to suspend the operation and refer to the processor status.

Among the techniques, the method most commonly used is to: define debug interrupts according to various purposes based on the interrupt mechanism of processors; interrupt the execution of a program by a processor by using a debug interrupt; and alternatively cause a program for debug interrupt processing to be executed in the processor.

To embody the interruption of program execution by using this conventional interrupt technique, it is necessary, in view of the characteristics of debugging as an object, to cause the program for debug interrupt processing to be executed without changing the status of the processor on which debugging is to be performed. This requires the separate provision of a memory apparatus for debugging which serves for evacuating, without damaging, the status of the processor at the time when an interrupt occurs.

As an exemplary case, a technique described in Patent Reference 1 (Japanese Unexamined Patent Application Publication No. H01-93838) is known. An “evacuation register” shown in FIG. 1 and an “alternate memory” shown in FIG. 5 of Patent Reference 1 correspond to the memory apparatus for evacuation that is provided for debugging.

For such a debug mechanism using interrupts as described in this exemplary case, various embodiments have been disclosed other lo than the one described above, but such embodiments have a common point that a memory apparatus is provided which evacuates, for debugging, the processor status at the time when an interrupt occurs.

Next, the case shall be described of configuring a virtual multiprocessor system by using a processor equipped with a debug mechanism using interrupts as described above.

First, configuring a virtual multiprocessor system requires holding the status of a logic processor for a period of time during which the logic processor is not assigned to a physical processor, so as to cause plural logic processors to switchably operate with respect to the physical processor. This requires a dedicated storage apparatus that stores the processor status of each of the logic processors.

As an exemplary case from the conventional technique, a technique described in Patent Reference 2 (Japanese Unexamined Patent Application Publication No. S59-167756) is known. A “VMC dedicated area” shown in FIG. 2 of Patent Reference 2 corresponds to the dedicated storage apparatus that stores the status of each logic processor.

For implementing the virtual multiprocessor system described in this exemplary case, various embodiments have been disclosed other than the one described above. Such embodiments have a common point that a dedicated storage apparatus for storing the status of each logic processor should be provided.

In order to configure, based on the conventional technique described above, a virtual processor system which implements, as a physical processor, a processor equipped with a debug mechanism using interrupts, it is necessary to switch among the contents stored in the memory apparatus for debugging which evacuates the processor status at the time when the debug interrupt occurs, concurrently with the switching of logic processors.

Therefore, an area for storing the contents of the memory apparatus for debugging needs to be provided on the dedicated storage apparatus for storing the status of each logic processor.

As a result, where N is the cost resulting from providing a memory apparatus for a physical processor, the cost for the virtual multiprocessor system in which the physical processor is made up of an M number of logic processors is:

N+(N×M)

with the result presenting a problem that larger costs are required than in the case of configuring a multiprocessor system made up of an M number of physical processors arranged in a row.

### SUMMARY OF THE INVENTION

The present invention is to solve the conventional problem described above, and it is an object of the present invention to provide a low-cost virtual multiprocessor system which requires no memory apparatus for debugging or no memory area for debugging on the storage apparatus at all for configuring a virtual multiprocessor system by using a physical processor equipped with a debug mechanism using interrupts.

In order to achieve the objective, a virtual multiprocessor system according to the present invention is a virtual multiprocessor system including: a physical processor which executes processing of a logic processor that is assigned to the physical processor; a storage unit for storing a piece of status information indicating a status of another logic processor that is not assigned to the physical processor; a dispatch unit which assigns to the physical processor, a logic processor from among plural logic processors through switching of the plural logic processors, to store into the storage unit, in response to the switching, a piece of status information corresponding to the logic processor assigned to the physical processor before the switching, and to read from the storage unit and write to the physical processor, a piece of status information corresponding to the logic processor assigned to the physical processor after the switching; and an interrupt unit which interrupts processing currently executed by the logic processor assigned to the physical processor by issuing a debug interrupt request to the logic processor, and the dispatch unit stores into the storage unit, a piece of status information corresponding to the logic processor assigned to the physical processor in response to the debug interrupt request issued to the logic processor.

According to the configuration, it is no longer necessary to provide a special memory apparatus for debugging that has conventionally been assumed as a requisite, by evacuating the processor status at the time when the debug interrupt is accepted. This allows reduction of the cost resulting for a virtual multiprocessor system from providing such a special memory for debugging that has conventionally been a requisite.

Preferably, the logic processor assigned to the physical processor executes debug interrupt processing in response to the debug interrupt request issued by the interrupt unit, and issues to the dispatch unit, an instruction to return from the debug interrupt processing upon completion of the debug interrupt processing, and the dispatch unit selects a logic processor from among the plural logic processors in response to the instruction to return from the debug interrupt processing so as to assign the selected logic processor to the physical processor, and reads from the storage unit and writes to the physical processor, a piece of status information corresponding to the logic processor assigned to the physical processor.

According to the configuration, a logic processor is selected in response to the instruction to return from debug interrupt that indicates the completion of the debug interrupt processing, and the status information of the selected logic processor is written to the physical processor. This allows returning from the debug interrupt processing.

In addition, the dispatch unit prohibits the switching of the plural logic processors when the debug interrupt request is accepted.

According to the configuration, the status information is not written into the storage unit since no switching of logic processors is performed. This prevents the status information, which has been evacuated at the point in time when the debug interrupt request is accepted, from being overwritten as a result of the switching of logic processors performed by the dispatch unit during execution of the debug interrupt processing.

Furthermore, preferably, the dispatch unit further prohibits storing into the storage unit, a piece of status information corresponding to the logic processor executing processing at a time when the debug interrupt processing is executed.

According to the configuration, during the switching of logic processors performed by the dispatch unit at the time of return from the debug interrupt processing, it is possible to prevent the status information, which is stored in the storage unit, from being overwritten with after-return status information.

According to the present invention, it is no longer necessary to provide a special memory apparatus for debugging, which has conventionally been a requisite, by evacuating to the storage apparatus, through the dispatch mechanism, the processor status at the time when the debug interrupt request is accepted, thereby producing an effect of reducing the cost resulting for the virtual multiprocessor system from providing the special memory unit for debugging that has conventionally been a requisite, with the cost being reduced by the amount: N+(N×M).

### FURTHER INFORMATION ABOUT TECHNICAL BACKGROUND TO THIS APPLICATION

The disclosure of Japanese Patent Application No. 2008-012810 filed on Jan. 23, 2008 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings which illustrate a specific embodiment of the invention. In the Drawings:

FIG. 1 is an external view of a virtual multiprocessor system according to an embodiment of the present invention;

FIG. 2 is a functional block diagram of the virtual multiprocessor system according to the embodiment of the present invention;

FIG. 3 is a diagram showing an exemplary ordinary operation of the virtual multiprocessor system according to the embodiment of the present invention; and

FIG. 4 is a diagram showing an exemplary operation during debugging of the virtual multiprocessor system according to the embodiment of the present invention.

### DESCRIPTION OF THE PREFERRED EMBODIMENT

Hereinafter, an embodiment of the present invention shall be described with reference to the drawings.

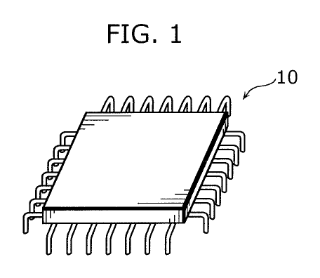

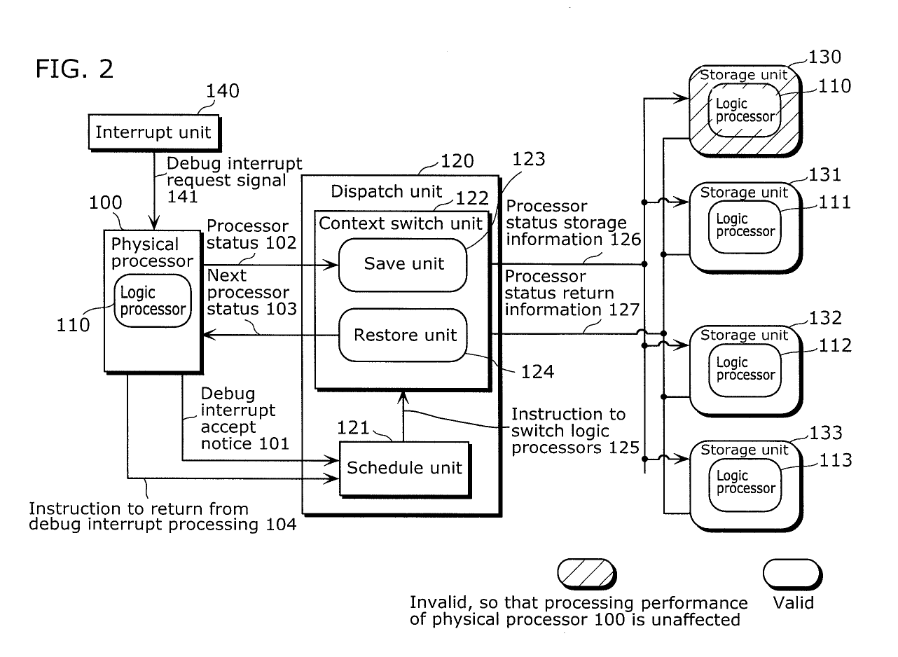

FIG. 1 is an external view of a virtual multiprocessor system according to the embodiment of the present invention. FIG. 2 is a functional block diagram of the virtual multiprocessor system according to the embodiment of the present invention.

A virtual multiprocessor system 10 is a virtually-implemented multiprocessor system and includes: a physical processor 100, logic processors 110 to 113, storage units 130 to 133, a dispatch unit 120, and an interrupt unit 140.

The physical processor 100 is a tangible processor which executes ordinary processing or interrupt processing.

The logic processors 110 to 113 are virtual processors that are implemented by the execution of ordinary processing or interrupt processing on the physical processor 100. For convenience of description, a logic processor 110 is assumed as the logic processor currently executing processing on the physical processor 100.

The storage units 130 to 133 are memory apparatuses for holding, respectively, the statuses of the logic processors while the logic processors are not implementing processing on the physical processor 100: the storage unit 130 holds the status of the logic processor 110; the storage unit 131 holds the status of the logic processor 111; the storage unit 132 holds the status of the logic processor 112; and the storage unit 133 holds the status of the logic processor 113.

The dispatch unit 120 is a processing unit which assigns the logic processors to the physical processor 100, and includes a schedule unit 121 and a context switch unit 122.

The schedule unit 121 is a processing unit which determines the next logic processor to be assigned to the physical processor 100 from among the logic processors 111 to 113 that are not currently assigned to the physical processor 100.

The context switch unit 122 is a processing unit which switches the logic processor 110 currently executing processing on the physical processor 100 to one of the logic processors 111 to 113 that is determined by the schedule unit 121 as the next logic processor to be assigned, and includes a save unit 123 and a restore unit 124.

The save unit 123 is a processing unit which transfers to the storage unit 130, the status of the logic processor 110 currently executing processing on the physical processor 100. The restore unit 124 is a processing unit which transfers (writes) to the physical processor 100, the content of one of the storage units 131 to 133 that corresponds to the next logic processor to be assigned to the physical processor 100.

The interrupt unit 140 is a processing unit which generates, for the logic processor intended to be suspended for debugging, a debug interrupt request signal 141 indicating a request for a debug interrupt.

Hereinafter, the operation of the debug mechanism of the thus-configured virtual multiprocessor system shall be described.

First, a normal operation of the virtual multiprocessor system 10 shall be described.

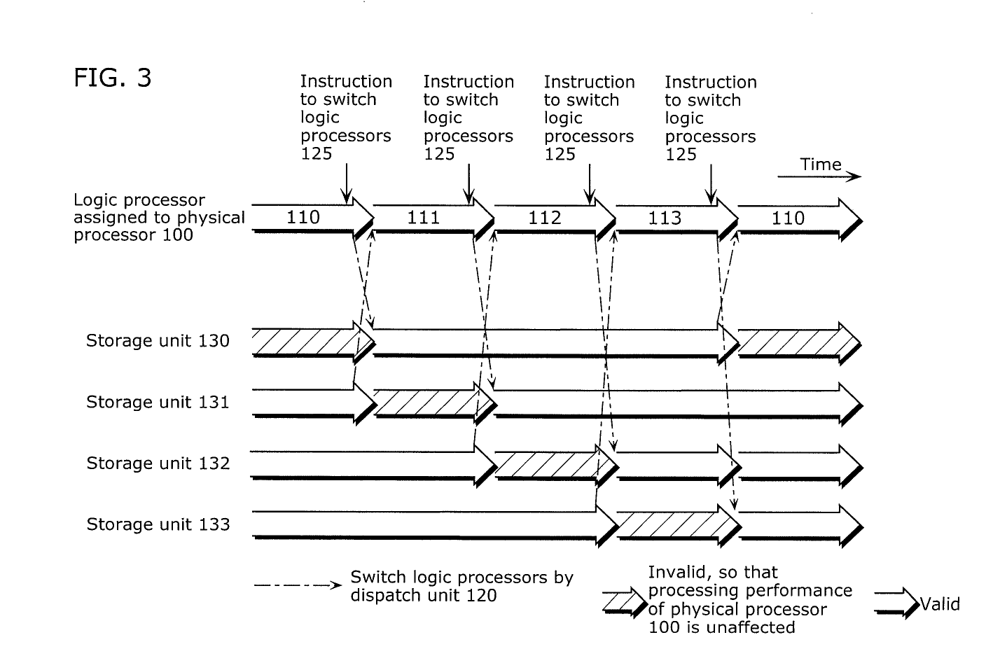

FIG. 3 is a diagram showing an exemplary ordinary operation of the virtual multiprocessor system 10 according to the embodiment of the present invention.

During the ordinary operation in which the interrupt unit 140 does not generate a debug interrupt request signal 141, upon issuance of an instruction to switch logic processors 125 that is issued by the schedule unit 121, the save unit 123 stores, as processor status storage information 126, the processor status 102 of the logic processor (one of the processors 110 to 113) currently assigned to the physical processor 100 into one of the storage units 130 to 133 that corresponds to the logic processor.

At the same time, the restore unit 124 takes out, as processor status return information 127, the logic processor status stored in a storage unit (one of the storage units 130 to 133) that corresponds to a logic processor (one of the logic processors 110 to 113) determined by the schedule 121 as the next logic processor to be assigned to the physical processor 100. The restore unit 124 transfers the processor status return information 127 that has been taken out to the physical processor 100 as the next processor status 103.

The save unit 123 and the restore unit 124 repeat the above processing according to the instruction to switch logic processors 125 issued by the schedule unit 121.

In the ordinary operation described above, the respective storage units become invalid, so that the operation of the processing currently executed on the physical processor 100 is unaffected: the storage unit 130 becomes invalid while the logic processor 110 is implementing processing on the physical processor 100; the storage unit 131 becomes invalid while the logic processor 111 is implementing processing; the storage unit 132 becomes invalid while the logic processor 112 is implementing processing; and the storage unit 133 becomes invalid while the logic processor 113 is implementing processing

Next, the operation of the virtual multiprocessor system 10 during debugging shall be described.

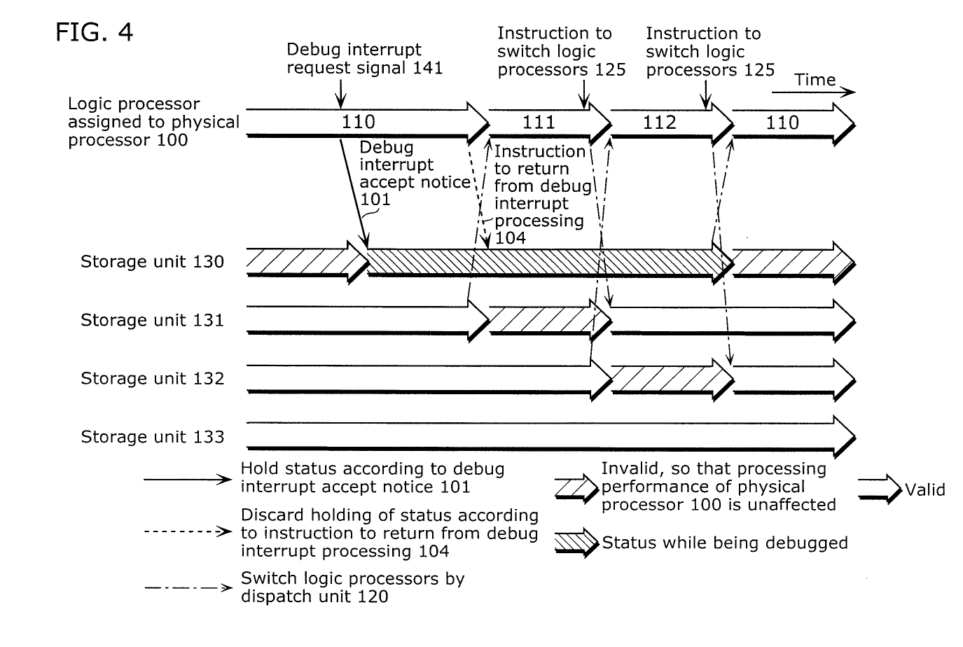

FIG. 4 is a diagram showing an example of the operation of the virtual multiprocessor system 10 during debugging according to the embodiment of the present invention. FIG. 4 shows the operation when the debug interrupt request signal 141 is generated while the logic processor 110 is implementing processing on the physical processor 100.

First, the interrupt unit 140 generates the debug interrupt request signal 141 for the logic processor 110. The request signal is accepted by the physical processor 100. Upon accepting the debug interrupt request signal 141, the physical processor 100 outputs a debug interrupt acceptance notice 101 to the schedule unit 121. Upon receiving the debug interrupt acceptance notice 101, the schedule unit 121 issues the instruction to switch logic processors 125 to the context switch unit 122 and activates the save unit 123. The save unit 123, when activated, writes, as the processor status storage information 126, the processor status 102 indicating the status of the logic processor 110 that has been stored at the time when the debug interrupt request signal 141 is accepted by the logic processor 110 that is currently implementing processing on the physical processor 100, to the storage unit 130 corresponding to the logic processor 110. With the operation described thus far, the operation of evacuating the processor status 102 at the time of the acceptance of the debug interrupt request signal 141 is completed.

After the completion of evacuating the processor status 102, the logic processor 110 currently implementing processing on the physical processor 100 continues execution of the interrupt processing in response to the debug interrupt request signal 141. Meanwhile, the schedule 121 moves into a state in which the issuance of the instruction to switch logic processors 125 to the context switch unit 122 is prohibited. Note that it is possible to arbitrarily release this prohibited state during the debug interrupt processing. With this operation, it is possible to prevent the information on the processor status 102 stored in the storage unit 130 from being overwritten as a result of the switching of logic processors performed by the dispatch unit 120 during the debug interrupt processing.

When an instruction to return from debug interrupt processing 104 that indicates the completion of the interrupt processing in response to the debug interrupt request signal 141 is issued to the schedule unit 121, the schedule unit 121 issues the instruction to switch logic processors 125. The context switch unit 122, having received the instruction to switch logic processors 125, starts switching logic processors, and the restore unit 124 transfers the processor status return information 127 to the physical processor 100 as the next processor status 103. At this time, the schedule unit 121 affects the save unit 123 so as to prevent the save unit 123 from storing the processor status 102 into the storage unit 130. With this, it is possible to prevent the processor status 102 at the time of the execution of the debug interrupt processing from being written into the storage unit 130.

At the point in time when the next logic processor 110 is assigned to the physical processor 100 after the switching of logic processors by the dispatch unit 120, the logic processor 110 returns to the state immediately before the generation of the debug interrupt request signal 141.

In the above exemplary operation, the case where the debug interrupt request signal 141 is issued to the logic processor 110 has been described. However, even in the case where the debug interrupt request signal 141 is issued to one of the logic processors 111, 112, and 113, the operation is the same as the above, except that the current storage unit is simply changed from the storage 130 to a corresponding one of the storage units 131, 132, and 133.

In addition, in the above exemplary operation, switching to one of the logic processors other than the logic processor 110 is performed after the issuance of the instruction to return from debug interrupt processing 104, but it is also possible to reassign the logic processor 110. In this case, likewise, the contents of the storage unit 130 are transferred to the physical processor 100 by the restore unit 124.

According to the operation described above, the storage unit 130 is caused to indicate the status of the logic processor 110 at the time of the generation of the debug interrupt request signal 141, during a period from when the debug interrupt request signal 141 is generated to when the instruction to return from debug interrupt processing 104 is issued, without affecting the debug interrupt processing being executed on the physical processor 110. This allows debugging of the logic processor 110 at an equivalent level to conventional debugging by using the contents of the storage unit 130, without any provision of a special memory unit for evacuating the processor status 102 for debugging that has conventionally been provided.

Thus far, the virtual multiprocessor system according to an embodiment of the present invention has been described, but the present invention is not limited to this embodiment.

For example, as FIG. 1 shows, the configuration of the virtual multiprocessor system is assumed as a single-chip Large Scale Integration (LSI), but the configuration is not necessarily limited to this. For example, a virtual multiprocessor system may also be implemented in ordinary computer configuration including a CPU, memory, and so on.

The embodiment disclosed above should be considered as exemplary, not as restrictive in all aspects. The scope of the present invention is specified not by Description but by What is claimed, and all modifications are intended to be included within the scope of the present invention.

### INDUSTRIAL APPLICABILITY

The present invention is applicable to a virtual multiprocessor system and so on which can implement a debug mechanism with small storage capacity.

What is claimed is:

1. A virtual multiprocessor system, comprising:
a physical processor which executes processing of a logic processor that is assigned to said physical processor;
a storage unit for storing a piece of status information indicating a status of another logic processor that is not assigned to said physical processor;
a dispatch unit configured to assign to said physical processor, a logic processor from among plural logic processors through switching of the plural logic processors, to store into said storage unit, in response to the switching, a piece of status information corresponding to the logic processor assigned to said physical processor before the switching, and to read from said storage unit and write to said physical processor, a piece of status information corresponding to the logic processor assigned to said physical processor after the switching; and
an interrupt unit configured to interrupt processing currently executed by the logic processor assigned to said physical processor by issuing a debug interrupt request to the logic processor,
wherein said dispatch unit is configured to store into said storage unit, a piece of status information corresponding to the logic processor assigned to said physical processor in response to the debug interrupt request issued to the logic processor.

2. The virtual multiprocessor system according to claim 1,
wherein the logic processor assigned to said physical processor is configured to execute debug interrupt processing in response to the debug interrupt request issued by said interrupt unit, and to issue to said dispatch unit, an instruction to return from the debug interrupt processing upon completion of the debug interrupt processing, and
said dispatch unit is configured to select a logic processor from among the plural logic processors in response to the instruction to return from the debug interrupt processing so as to assign the lo selected logic processor to said physical processor, and to read from said storage unit and write to said physical processor, a piece of status information corresponding to the logic processor assigned to the physical processor.

3. The virtual multiprocessor system according to claim 2,
wherein said dispatch unit is configured to prohibit the switching of the plural logic processors when the debug interrupt request is accepted.

4. The virtual multiprocessor system according to claim 2,
wherein said dispatch unit is further configured to prohibit storing into said storage unit, a piece of status information corresponding to the logic processor executing processing at a time when the debug interrupt processing is executed.

5. The virtual multiprocessor system according to claim 1,
wherein a piece of status information among the pieces of status information stored in said storage unit becomes invalid, so that performance of the processing currently executed on said physical processor is unaffected, the piece of status information corresponding to the logic processor currently executing the processing on said physical processor.
